(19) United States
(12) Patent Application Publication
(10) Pub. No.: US 2009/0311575 A1
(43) Pub. Date: Dec. 17, 2009

(54) Fuel cell with passive operation

(75) Inventor: Brian David Babcock, Bloomington, MN (US)

Correspondence Address: BRENDAN BABCOCK, 1814 Rock Springs Road, Columbia, TN, 38401, US

(73) Assignee: Brian David Babcock, Bloomington, MN (US)

(21) Appl. No.: 12/455,636

(22) Filed: Jun. 4, 2009

Related U.S. Application Data
(60) Provisional application No. 61/131,285, filed on Jun. 6, 2008.

(51) Int. Cl. H01M 2/00

(52) U.S. Cl. 429/34

(57) ABSTRACT

A fuel cell comprising an anode and cathode, fuel delivery means comprising a superabsorbent nonwoven absorbent media in fluid contact with a wicking material, gas-liquid separation means, and water management means. In one embodiment, the fuel cell also uses a microporous membrane, a wicking material, and an absorbent material to provide for gas-liquid separation, and a wicking material and absorbent material to provide for liquid management means at the cathode. In some embodiments, the combination of materials provides the advantage of passive operation and orientation independence for the fuel cell.

### CROSS-REFERENCES TO RELATED APPLICATIONS

This application claims the benefit of U.S. Provisional Patent Application Ser. No. 61/131,285, entitled “Fuel Cell with Passive Operation,” filed Jun. 6, 2008, the contents of which is herein incorporated by reference in its entirety.

### STATEMENT REGARDING FEDERALLY SPONSORED RESEARCH OR DEVELOPMENT

Not Applicable

### PARTIES TO A JOINT RESEARCH AGREEMENT

Not Applicable

### FIELD OF THE INVENTION

This invention is an improved fuel cell design that uses media layers to deliver fuel to the anode reaction site, provide gas-liquid separation at the anode site, and manages liquid production at the cathode site. The fuel cell comprises a superabsorbent material with a wicking material to deliver fuel, and combinations of microporous membranes, wicking materials, and absorbent materials together to separate gas and vapor from the liquid fuel and transfer or store the condensed liquid from the fuel cell. The fuel cell offers the advantages of on-demand fuel delivery, passive design, and orientation independence.

### BACKGROUND OF THE INVENTION

Fuel cells are electrochemical cells in which a free energy change resulting from a fuel oxidation reaction is converted into electrical energy. Because of their comparatively high inherent efficiencies and comparatively low emissions, fuel cells are presently receiving considerable attention as a possible alternative to the combustion of nonrenewable fossil fuels in a variety of applications.

A typical fuel cell comprises a fuel electrode (i.e, anode) and an oxidant electrode (i.e., cathode), the two electrodes being separated by an ion-conducting electrolyte. The electrodes are connected electrically to a load, such as an electronic circuit, by an external circuit conductor. Oxidation of the fuel at the anode produces electrons that flow through the external circuit to the cathode producing an electric current. The electrons react with an oxidant at the cathode. In theory, any substance capable of chemical oxidation that can be supplied continuously to the anode can serve as the fuel for the fuel cell, and any material that can be reduced at a sufficient rate at the cathode can serve as the oxidant for the fuel cell.

In one well-known type of fuel cell, sometimes referred to as a hydrogen fuel cell, gaseous hydrogen serves as the fuel, and gaseous oxygen, which is typically supplied from the air, serves as the oxidant. The electrodes in a hydrogen fuel cell are typically porous to permit the gas-electrolyte junction to be as great as possible. At the anode, incoming hydrogen gas ionizes to produce hydrogen ions and electrons. Since the electrolyte is a non-electronic conductor, the electrons flow away from the anode via the external circuit, producing an electric current. At the cathode, oxygen gas reacts with the hydrogen ions migrating through the electrolyte and the incoming electrons from the external circuit to produce water as a byproduct. The overall reaction that takes place in the fuel cell is the sum of the anode and cathode reactions, with part of the free energy of reaction being released directly as electrical energy and with another part of the free energy being released as heat at the fuel cell.

It can be seen that as long as oxygen and hydrogen are fed to a hydrogen fuel cell, the flow of electric current will be sustained by electronic flow in the external circuit and ionic flow in the electrolyte. Oxygen, which is naturally abundant in air, can easily be continuously provided to the fuel cell. Hydrogen, however, is not so readily available and specific measures must be taken to ensure its provision to the fuel cell. One such measure for providing hydrogen to the fuel cell involves storing a supply of hydrogen gas and dispensing the hydrogen gas from the stored supply to the fuel cell as needed. Another such measure involves storing a supply of an organic fuel, such as methanol, and then reforming or processing the organic fuel into hydrogen gas, which is then made available to the fuel cell. However, as can readily be appreciated, the reforming or processing of the organic fuel into hydrogen gas requires special equipment (adding weight and size to the system) and itself requires the expenditure of energy.

Accordingly, in another well-known type of fuel cell, sometimes referred to as a direct organic fuel cell, an organic fuel is itself oxidized at the anode. Examples of such organic fuels include methanol, ethanol, propanol, isopropanol, trimethoxymethane, dimethoxymethane, dimethyl ether, trioxane, formaldehyde, and formic acid. Typically, the electrolyte in such a fuel cell is a solid polymer electrolyte or proton exchange membrane (PEM). (Because of the need for water in PEM fuel cells, the operating temperature for such fuel cells is limited to approximately 130° C.) In operation, the organic fuel is delivered to the anode in the form of a fuel/water mixture, and airborne oxygen is delivered to the cathode. (Oxidants other than oxygen, such as hydrogen peroxide, may also be used.) Protons are formed by oxidation of the organic fuel at the anode and pass through the proton exchange membrane to the cathode. Electrons produced at the anode in the oxidation reaction flow in the external circuit to the cathode, driven by the difference in electric potential between the anode and the cathode and, therefore, can do useful work. A summary of the electrochemical reactions occurring in a direct organic fuel cell (with methanol illustratively shown as the organic fuel) are as follows:

Anode: CH₃OH+H₂O→CO₂+6H⁺+6e⁻ (1)

Cathode: 1.5O₂+6H⁺+6e⁻→3H₂O (2)

Overall: CH₃OH+1.5O₂→CO₂+2H₂O (3)

At present, there are two different types of systems that incorporate direct organic fuel cells, namely, liquid feed systems and vapor feed systems. Examples of liquid feed systems are disclosed in the following U.S. patents, all of which are incorporated herein by reference: U.S. Pat. No. 5,992,008, inventor Kindler, issued Nov. 30, 1999; U.S. Pat. No. 5,945,231, inventor Narayanan et al., issued Aug. 31, 1999; U.S. Pat. No. 5,599,638, inventors Surampudi et al., issued Feb. 4, 1997; and U.S. Pat. No. 5,523,177, inventors Kosek et al., issued Jun. 4, 1996.

In a typical liquid feed system, a dilute aqueous solution of the organic fuel (i.e., approximately 3-5 wt % or 0.5-1.5 M organic fuel) is delivered to the fuel cell anode whereupon said aqueous solution diffuses to the active catalytic sites of the anode, and the fuel therein is oxidized. The liquid feed system is typically operated at 60° C.-90° C. although operation at higher temperatures is possible by pressurizing the anode and the fuel supply system. (For operation at temperatures greater than 100° C., cathode pressurization is additionally required.)

As can readily be appreciated, it would be desirable to increase fuel cell performance in a liquid feed system by using a more concentrated solution of the organic fuel than the approximately 3-5 wt % solution described above. Unfortunately, however, the proton exchange membrane typically used in a liquid feed system is rather permeable to the organic fuel. As a result, a substantial portion of the organic fuel delivered to the anode has a tendency to permeate through the proton exchange membrane, instead of being oxidized at the anode. Moreover, much of the fuel that transits the proton exchange membrane is chemically reacted at the cathode and, therefore, cannot be collected and recirculated to the anode. This type of fuel loss, which can total as much as 50% of the fuel, is referred to in the art as crossover. In addition, this problem of cross-over is exacerbated if the concentration of organic fuel in the aqueous solution is increased beyond the approximately 3-5 wt % described above since the permeability of the proton exchange membrane increases exponentially as the organic fuel concentration increases. The build-up of pressure inside the fuel cell stack also increases the organic fuel crossover.

Consequently, because the concentration of organic fuel in the aqueous solution must remain relatively low to minimize cross-over, large quantities of water must be made available for diluting the organic fuel to appropriate levels. However, as can be appreciated, the required quantities of water can be heavy and space-consuming and can pose a problem to the portability of the system. Moreover, equipment for mixing the water and the organic fuel in the appropriate amounts, for re-circulating water generated at the cathode and for monitoring the concentration of the organic fuel in the aqueous solution is often needed as well.

Another complication resulting from the high concentration of water present in the aqueous solution is that a considerable amount of water delivered to the anode also permeates through the proton exchange membrane to the cathode. This excess water arriving at the cathode limits the accessibility of the cathode to gaseous oxygen, which must be reduced at the cathode to complement the oxidation of the fuel at the anode. This phenomenon of the permeating water accumulating at the cathode and, thereby, limiting the accessibility of the cathode to gaseous oxygen is referred to in the art as flooding. As can readily be appreciated, flooding adversely affects fuel cell performance.

In a typical vapor feed system, the aqueous solution of organic fuel and water is vaporized prior to entering the fuel cell and is then fed, in vapor form, to the anode. Because the proton exchange membrane is less permeable to the fuel/water mixture in vapor form than it is to the fuel/water mixture in liquid form, the above-described problems of cross-over and flooding are less pronounced in a vapor feed system. As a result, fuel cell performance and fuel efficiency are typically greater in a vapor feed system than in a liquid feed system. Moreover, due to the decreased permeability of the membrane to the fuel/water mixture in its vapor form, a higher concentration of the organic fuel may be employed in a vapor feed system.

However, some of the disadvantages of a typical vapor feed system are that the system must be operated at above 100° C. in order to prevent condensation of the fuel/water mixture at the anode. In addition, the fuel/water mixture must be vaporized prior to entering the fuel cell. As can be appreciated, the foregoing conditions require the use of specialized equipment that is space-consuming and that requires the expenditure of energy for its own operation. Moreover, due to the amount of heat that is generated as an unwanted byproduct in the fuel cell, a vapor feed system must also include a cooling assembly, typically in the form of coolant plates and a circulating coolant, to keep the fuel cell from getting too hot. Such a cooling assembly can add considerable weight and volume to the system, especially if a multi-cell stack is used, since one cooling plate is needed for every 2-5 active cells. (By contrast, in a liquid feed system, the aqueous solution, in addition to containing the fuel, also serves as a coolant for the system.)

There remains a need for a low-cost fuel cell that can passively operate to deliver fuel to the reaction site, provide effective gas-liquid separation at low pressure drop, manage liquid flows within the stack assembly, and operate independent of orientation.

### SUMMARY OF THE INVENTION

The present invention is directed to low-cost fuel cells with passive operation of the balance-of-plant components that deal with fuel delivery, gas-liquid separation, liquid management, and other fuel cell operations. The invention uses combinations of wicking and absorbent materials to perform these functions in the fuel cell.

The invention can be used with multiple types of fuel cells. Most fuel cells will benefit from one or more aspects of this invention. Because fuel cells rely on reactions at the anode and cathode sites, all fuel cells have a need for effective delivery of fuel to each site. Virtually all fuel cells use or produce liquid and gas products that need to be separated. All fuel cells have a need to effectively manage the liquids that are produced from the stack.

### BRIEF DESCRIPTION OF THE DRAWINGS

FIG. 1 is a drawing showing the cross-section of one embodiment for the fuel cell without flow field plates.

FIG. 2 is a schematic of the test cell used to test an experimental cell using the components of the invention.

FIG. 3 is a graph of the current and voltage curves for materials tested using the test cell in FIG. 2.

FIG. 4 is a graph of the performance curves for materials tested using the test cell in FIG. 2.

FIG. 5 is a graph of the performance curves for materials tested using the test cell in FIG. 2 when the cell was operated upside down.

FIG. 6 is a graph showing the improvement in operating life of a gas-liquid separator using the composite materials from this invention.

FIG. 7 shows one embodiment for incorporating the gas-liquid separator means of this invention into a flow field plate at the anode site.

FIG. 8 is a drawing for an embodiment utilizing materials from this invention to prevent cathode flooding.

FIG. 9 is a graph showing the ability of wicking and absorbent layer combinations to maintain air permeability while absorbing water.

FIGS. 10A-10F show different embodiments for wicking and absorbent layers to use at the cathode and anode sites.

FIG. 11 shows one embodiment for incorporating the water management means of this invention into a flow field plate at the cathode site.

### DETAILED DESCRIPTION OF THE INVENTION

A fuel cell stack design can be assembled by combining specialty media layers with the Membrane Electrode Assembly (MEA) materials to produce a thin, low-cost fuel cell suitable for portable applications. The media layers provide the following functions in the fuel cell:

Fuel delivery means

Gas-liquid separation at the anode site

Water management and oxygen delivery at the cathode site.

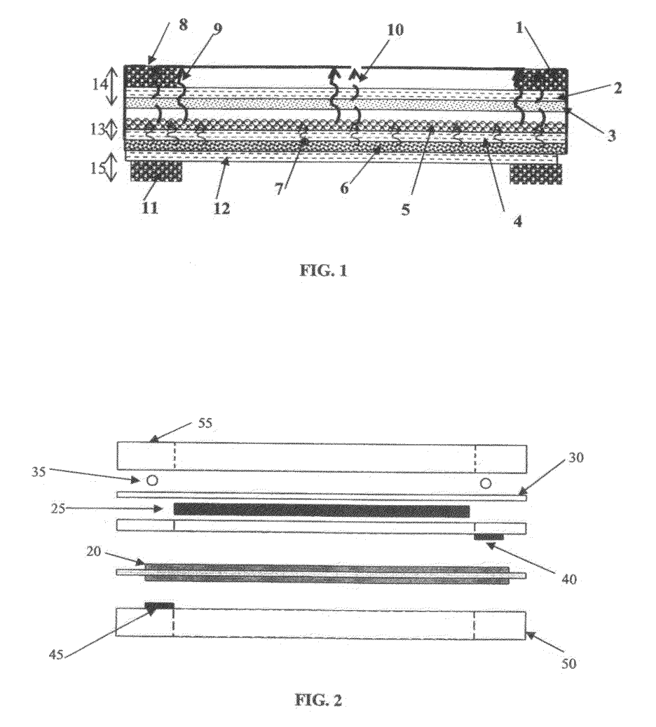

Combining all three components (fuel delivery, gas-liquid separator (GLS), and liquid management) with a membrane electrode assembly (MEA) containing anode and cathode catalysts on either side results in an operational fuel cell stack. FIG. 1 shows an embodiment of the fuel cell design that gives additional detail on each layer of the stack components.

In FIG. 1, fuel is stored in the absorbent layer 5 of the fuel delivery material and is transferred by the wicking layer 4 of the fuel delivery material to the anode side of the MEA 6. The absorbent layer 5 and the wicking layer 4 comprise the fuel delivery means 13 of the fuel cell. As a result of the fuel cell reaction, carbon dioxide gas 7 is produced at the anode. Fuel vapor 9 is also produced at the anode as the reaction proceeds and the temperature of the fuel cell increases. The fuel vapor and carbon dioxide gases pass into the gas-liquid separator (GLS) portion of the fuel cell.

The gas-liquid separator means 14 comprises a microporous membrane 3, a wicking material 2 in contact with the microporous membrane and an absorbent material 1 in contact with the wicking material 2. Because the temperature, pressure, and relative humidity on the downstream side of the GLS are lower than the conditions inside the fuel cell stack, vapor 9 will condense on the downstream side. To prevent the condensed vapor from plugging the membrane 3, wicking material 2 absorbs condensation and transfers it to the absorbent material 1. This allows the carbon dioxide gas 10 to vent out of the fuel cell stack through the vent openings 8 while recovering the condensed fuel.

The liquid management means 15 is located at the cathode side of the fuel cell. At the cathode, water produced by the fuel cell reaction is absorbed by the wicking material 12 and transferred to the absorbent material 11. The wicking and absorbent layers work together to remove water from the cathode surface while allowing sufficient air to reach the cathode and provide fuel for the fuel cell to continue to operate. This portion of the design prevents the fuel cell from suffering the problem of cathode flooding.

The location of the absorbents (1, 5, and 11), vents (8), and wicking materials (3, 4, and 12) can be changed with the design of the fuel cell. In some cases it may be desired to wick most of the liquid back to be recycled and the absorbent layer is only intended to absorb a “surge” of liquid that would otherwise overwhelm the fuel cell. The absorbent layers can also be located outside the stack to minimize thickness, as long as they remain in fluid contact with the wicking materials.

Further details on the performance of the fuel delivery, gas-liquid separators, and cathode liquid management sections are described later in this application.

The fuel cell design could also be used for fuel cells that deliver fuel to the cathode and have water produced at the anode site. Although current drawings show the fuel cell design being used for fuel cells with fuel being delivered to the anode, the design could work with fuel cells that deliver fuels to the cathode by using the fuel delivery and gas-liquid separation means at the cathode site and using the liquid management means at the anode site. Multiple cells could be connected to produce a thin multi-cell fuel cell. The advantage to the invention is that it can be used with fuel cells that use a wide variety of catalysts, fuels, and electrode materials. The invention handles much of the balance of plant issues associated with a fuel cell and can be optimized with specific fuel cell parameters such as shape and operational requirements. In addition, because condensation occurs in most fuel cells, components of the gas-liquid separation and water management means can be used in fuel cells that use vapor rather than liquid fuel feeds.

A wide variety of materials can be used as either absorbent or wicking layers. Choices for absorbent media include numerous absorbent fleece materials from BASF under the LuquaFleece® brand, superabsorbent fiber materials sold under the OASIS® brand from Technical Absorbents as well as other superabsorbent materials available from Concert Industries located in Gatineau, Canada. Commercially available wicking materials include rayon materials sold under the Snotemp® brand, polyester/rayon materials sold under the Snofil® brand, and polyester/cellulose materials sold under the Snoweb® brand. In addition, wicking materials comprising glass fibers are available from Ahlstrom, Hollingsworth and Vose, Owens-Corning, and other material suppliers; these types of glass materials are commonly used in battery separator and diagnostic applications. Table 1 and Table 2 give properties for various commercially available materials that could be selected for use in this invention; material choices are not limited to those shown in the table.

TABLE 1
Physical Properties of Commercial Absorbent Materials

| | | | | | Absorbent |
|---|---|---|---|---|---|
| | Commercial | Basis | | | Capacity |
| Type of | Material | Weight | Permeability | Thickness | (gH₂O/g |
| Material | Sample | (g/m²) | (cfm/ft²) | (.001 in) | Mat) |
| Absorbent | 1 | 256 | 1401 | 82.46 | 30.51 |
| Fleece | 2 | 300 | 1358 | 88.66 | 25.08 |
| | 3 | 484 | 1164 | 127.7 | 20.84 |
| | 4 | 257 | 1280 | 48.44 | 31.8 |
| | 5 | 304 | 1192 | 50.86 | 27.14 |
| | 6 | 468 | 928.4 | 61.72 | 22.57 |
| Absorbent | 7 | 115 | 262 | .038 | 41.5 |
| airlaid | 8 | 215 | 127 | .068 | 41.8 |
| | 9 | 320 | 114 | .071 | 45 |
| | 10 | 322 | 32 | .073 | 25 |
| | 11 | 322 | 49 | .073 | 28 |
| | 12 | 200 | 120 | .054 | 33.4 |
| | 13 | 96 | 617 | .032 | 69.7 |
| | 14 | 136 | 200 | .041 | 30 |
| | 15 | 558 | 69.2 | .106 | 23 |

TABLE 2
Physical Properties of Commercial Wicking Materials

| | Material | Basis Weight | Permeability | Thickness |
|---|---|---|---|---|
| | ID | (oz/yd²) | (cfm/ft²) | (mils) |
| Rayon | 1 | 0.8 | 550 | 6 |
| | 2 | 1.0 | 425 | 8 |
| | 3 | 1.5 | 290 | 11 |
| | 4 | 1.9 | 250 | 14 |
| | 5 | 2.25 | 210 | 14 |
| | 6 | 2.80 | 245 | 20 |
| Rayon/ | 7 | 0.6 | 965 | 6 |
| Polyester | 8 | 0.7 | 725 | 6 |
| | 9 | 0.8 | 710 | 7 |
| | 10 | 1.0 | 515 | 8 |
| | 11 | 1.25 | 495 | 10 |
| Polyester/ | 12 | 0.8 | 610 | 7.75 |
| cellulose | 13 | 1.0 | 480 | 9 |
| | 14 | 1.25 | 180 | 8 |
| | 15 | 1.5 | 370 | 14 |
| | 16 | 1.8 | 295 | 15 |
| | 17 | 2.5 | 135 | 13.5 |

Descriptions and data provided are for direct methanol fuel cell applications although the design would work with other fuel cell systems. The components of the system will be separated and described in separate sections.

### Fuel Delivery

In a preferred embodiment, the fuel cell does not use flow field plates, reducing the size and cost of the fuel cell. Instead, the wicking layer transfers fuel from the absorbent media to the catalyst surface. The wicking layer can also function as an effective diffusion layer, eliminating the need for a separate gas diffusion layer. The components of the invention, notably the gas-liquid separator and the cathode liquid management components, can be integrated into systems that use flow field plates to transfer fuel to the fluid delivery section at the anode and air or oxygen at the cathode.

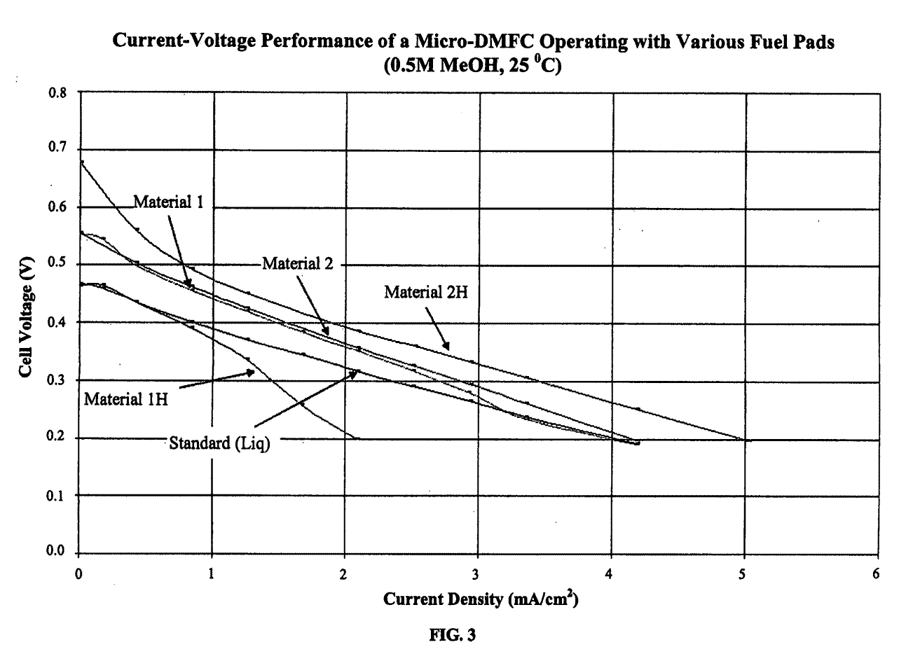

Concepts for fuel delivery were tested using a test cell shown in FIG. 2. The materials tested as fuel delivery media were as follows:
Material 1: Commercial wicking material #6 from Table 2
Material 1H: same material as Material 1, but with 0.25-in diameter holes die cut every 1 inch
Material 2: Commercial wicking material #6 from Table 2 combined with absorbent material #7 from Table 1
Material 2H: same as Material 2 but with 0.25-in diameter holes die cut every 1 inch

Materials were tested in a single-cell direct methanol fuel cell test design; the schematic of the test fuel cell is shown in FIG. 2. The cell was a stagnant cell that used a single initial charge of fuel during the test; no liquid was pumped to the cell during the test. For the standard test, the cell volume was filled with 0.5M methanol fuel and the current and voltage outputs of the cell were measured over time. To test the fuel delivery materials, instead of filling the cell volume with liquid fuel, each material was placed in a container of the 0.5M methanol liquid fuel and allowed to absorb the fuel. The absorbent material was an airlaid material containing 40% superabsorbent fiber, 48% cellulose pulp, and 12% polyester/polypropylene fiber by weight. The wet media was then placed inside the cell with the wicking layer facing the anode side of the cell.

During the test, fuel from the fuel delivery material 25 was delivered to the anode side of the method electrode assembly (MEA) 20. Current collectors 40 and 45 were used to conduct the electricity produced by the cell. Carbon dioxide and other vapors were vented through a 0.006″ ePTFE membrane 30 with a Frazier air perm of 0.3 ft/min. The fuel cell was clamped between plates 50 and 55 with openings in the center that allowed for air exchange with the environment. Gaskets 35 were used on the anode side of the fuel cell to seal the fuel cell against the plates.

Results for the new fuel cell design show that the fuel delivery method allows for on-demand delivery of fuel to the reaction site without the need for pumps or controllers. This advantage results in a higher power output of the fuel cell and a more stable voltage. These results can be seen in FIGS. 3-5.

FIGS. 3-5 are results that were achieved when testing a single cell design. FIG. 3 shows that the use of wicking layers to deliver fuel to the anode gave a higher cell voltage over direct contact of the anode with the liquid fuel alone. Cell voltages were up to 30% higher for materials 2H than for the standard. For Material 2H, holes were die-cut into the wicking layer and the layer to provide for additional gas venting through the material.

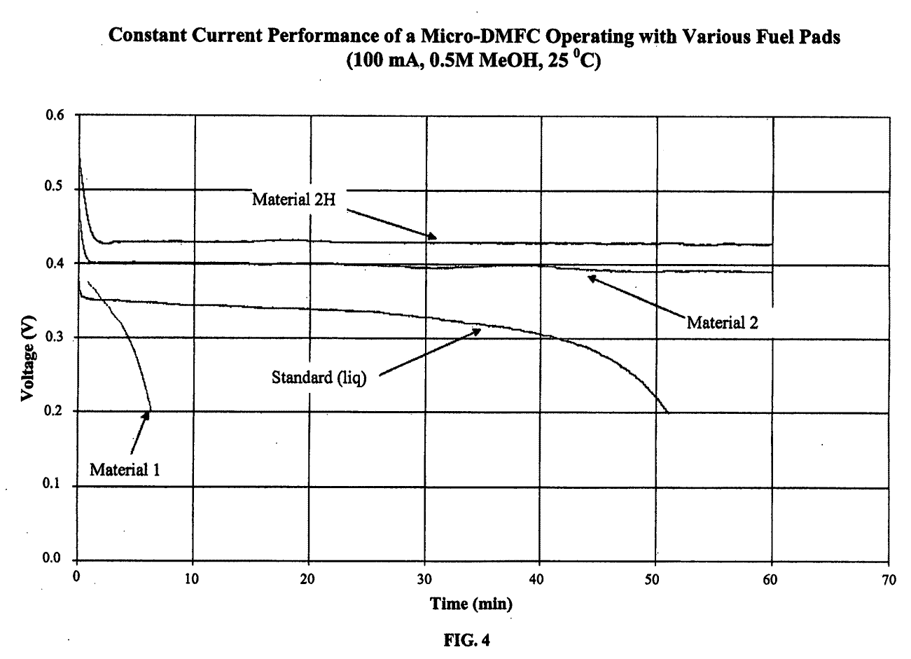

FIG. 4 shows the improvement achieved by the use of the absorbent and wicking layers for fuel delivery. As seen in the curves, Material 2H and Material 2 are able to maintain a stable voltage while the standard liquid cell is not. The curves demonstrate that the absorbent and wicking materials in Materials 2 and 2H provide on-demand fuel delivery. Without being limited by theory, it is theorized that because the wicking material maintains some air permeability, localized pressures do not build up from the reaction gases produced at anode reaction sites, which allows the cell to achieve more stable operation. In contrast, a straight liquid feed does not allow reaction gases to vent effectively from the reaction site, which results in a decreased reaction rate and lower voltage for the cell. Material 1 was a wicking material alone and did not have enough stored fuel to run the cell for an hour.

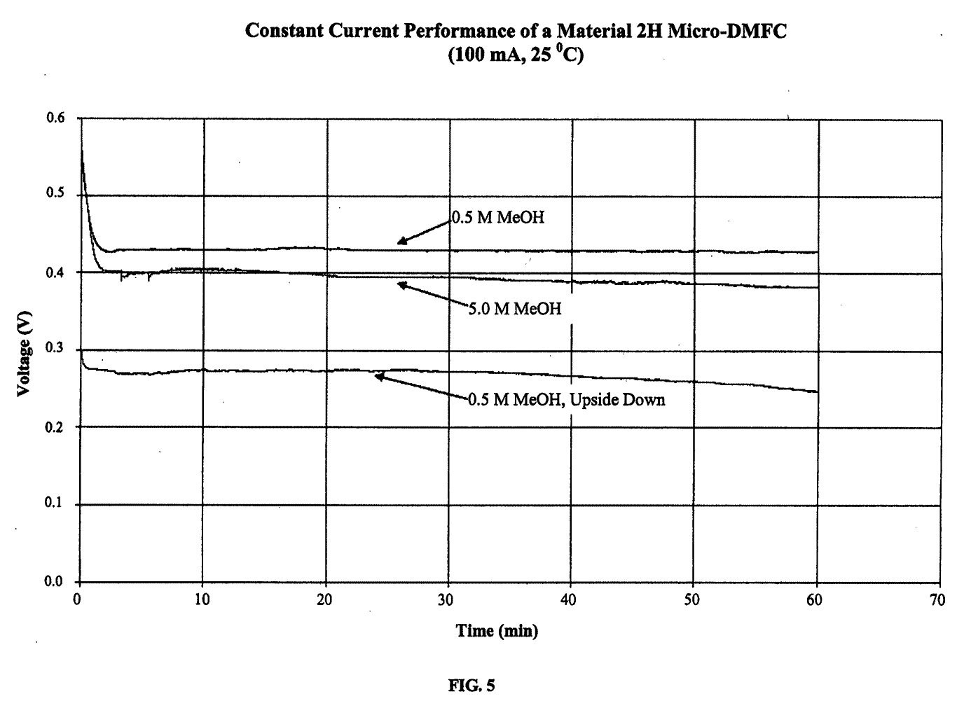

FIG. 5 shows that the use of wicking and absorbent materials for fuel delivery results in a fuel cell that can operate independent of orientation. Even though the cell was operated upside down, the wicking material was able to deliver the fuel to the anode site and overcome the effects of gravity. As shown in FIG. 5, the cell was able to maintain a steady voltage even when it was operated upside down (though the voltage was lower). The standard cell using a liquid only could not operate upside down because it could not consistently deliver fuel to the anode.

### Gas-Liquid Separation at Reaction Site

In liquid-fed fuel cells, such as a direct methanol fuel cell, a liquid solution is delivered to the anode surface where it reacts to generate hydrogen ions, free electrons, and vapor by-products. For a direct methanol fuel cell, the methanol reacts in the presence of the anode catalysts to generate hydrogen ions and free electrons for the fuel cell and carbon dioxide gas as a by-product. The carbon dioxide needs to be removed from the fuel cell in order for the fuel cell to continue operating properly. Problems that can occur if the carbon dioxide (or other vapor by-product) is not removed include the following:
1. Increasing concentration of carbon dioxide will eventually stop the anode reaction.
2. The pressure will build up inside the fuel cell stack, preventing liquid from reaching the catalyst.
3. Increasing pressure within the fuel cell can also force the liquid methanol or other liquid fuel across the membranes in the fuel cell stack, shorting out the fuel cell.
4. Increasing pressure from the carbon dioxide can force liquid through membranes used in other parts of the fuel cell outside the membrane stack.

Membranes have traditionally been used in gas-liquid separations, usually in applications where the membrane does not maintain contact with the liquid at all times. However, as devices such as micro-fuel cells get smaller, space limitations require that the liquid solution contact the membrane material while also venting gases. In some fuel cell designs, it is desired for the solution to flow along the surface of the membrane while gas vents through the walls. In the prior art, a gas-liquid separator is typically positioned outside the fuel cell membrane stack. The mixed phase liquid exiting the anode is fed to the external gas-liquid separator where the gas vents through the membrane and the liquid is returned to the fuel cell. Membranes for vent applications in the prior art have one or more of the following disadvantages:
1) The membranes are wet by the solution and either require high pressure to vent gas or stop venting gas altogether.
2) The membranes are not strong enough to withstand pressure fluctuations in the system, resulting in liquid being forced through the membranes.
3) Thicker or stronger membranes able to support the pressure fluctuations do not have sufficient porosity to allow gas to vent effectively.
4) Membranes are permeable to solution vapor as well as gas, resulting in a loss of solution through the vent.
5) Solution vapor that passes through the membrane can condense on the outside, resulting in either a higher pressure drop required to vent gas and/or a reduction or elimination of the overall gas flow.
6) At higher operating temperatures (40 C. and above), the amount of condensed vapor greatly increases and rapidly stops any gas from venting, stopping the fuel cell from operating.

The first four problems can often be addressed by varying the membrane properties (pore size, surface energy, etc.) and adding support scrims to the outside of the membrane. The membrane surface area can be increased to vent sufficient quantities of gas, but increasing the surface area conflicts with the goal of reducing the overall size of the fuel cell components. However, changing the membrane properties does not solve the problems caused by condensation of solution vapor.

There are also problems with using a separate gas-liquid separator outside the fuel cell stack. These problems include the following:
1) It increases the overall size of the fuel cell
2) It does not prevent localized pressures from building up within the channels of the flow field plates or other fuel delivery means.
3) Its performance will vary greatly with the operating conditions of the fuel cell.

It is necessary to integrate the gas-liquid separator with the fuel cell stack components to enable the needed size reduction in the overall fuel cell and to provide a means to best control the gas and liquid streams where they are produced.

In one embodiment, the gas-liquid separation (GLS) composite media comprising a microporous membrane, a wicking material, and an absorbent material is located inside the stack; it can be in contact with the fuel delivery layer. The liquid solution flows through the fuel delivery media where it is delivered to the anode surface and reacts. The carbon dioxide and vapor by-products produced from the reaction vents directly through the porous fuel delivery layer and the GLS composite media. As the anode reaction proceeds, the temperature of the fuel cell increases and the vapor content of the fuel increases; some of the fuel vapor will also vent through the membrane of the GLS composite. In the GLS composite, the wicking material on the downstream side of the microporous membrane absorbs any fuel vapor that condenses and wicks it another location—either to be stored by the absorbent material of the GLS composite or recycled back to the fuel cell. The wicking layer also prevents condensation from forming on the membrane layer, keeping the membrane open for venting. The absorbent media is in fluid contact with the wicking material and can be located in discrete areas so that it does not restrict air flow through the membrane as it absorbs liquid. It is necessary to keep a wicking material between the membrane and the absorbent material; if the absorbent is directly in contact with the membrane, as it absorbs larger amounts of condensed fuel its pores will tend to swell closed right at the interface with the membrane and further gas flow will be restricted.

The preferred embodiment of the GLS comprises a microporous membrane layer with a wicking material on the downstream side and a superabsorbent media in contact with the wicking layer. The membrane is naturally hydrophobic and resists wetting by the solution. The membrane can be ePTFE with a thickness of 0.003-0.010 inches thick and an air permeability of 0.2-2.5 cfm @ 125 Pa. The wicking layer comprises a lightweight media of 100 gsm or less with a Frazier perm of over 100 ft/min, and the absorbent is a superabsorbent nonwoven media The Frazier perm of the superabsorbent media can vary depending on how it is integrated into the fuel cell.

One or more additional scrim layers can be placed on the upstream side of the membrane to reduce the amount of solution vapor that vents through the membrane. Both the membrane and the upstream scrim layers can be treated with a hydrophobic or oleophobic treatment to further resist wetting by the liquid fuel. Table 3 shows the effect of additional upstream scrim layers on the loss of solution. For these tests, air was bubbled through a 3% methanol solution at a rate of 50 cc/min and vented out through different membrane/scrim composites for 24 hours at room temperature. The amount of solution remaining in the container was measured and compared to the starting amount. Total vent area for the test was 0.66 square centimeters. The scrim layers used in samples 3, 4, and 5 were 2.8-osy Type 23 Cerex® materials manufactured by Western Nonwovens that were coated with an oleophobic treatment while the scrim layers used in sample 6 were Hollytex® 3257 polyester samples that did not have an oleophobic treatment. All the tests shown in Table 1 used a single layer of Reemay® 2295 scrim on the downstream side of the membrane.

TABLE 3
Affect of Upstream Scrim Layers on Solution Loss

| | | | | Final | |
|---|---|---|---|---|---|
| | | Air | Starting | Amount | Percent |
| | | Permeability | Amount of | of | of |
| | Membrane/Scrim | (Ft/min @ | Solution | Solution | Solution |
| Sample | Tested | 125 Pa) | (mL) | (mL) | Loss |
| 1) | 0.009″-thick | 0.12 | 17 | 12 | 29.41 |
| | ePTFE (no scrim) | | | | |
| 2) | 0.0035″-thick | 2.5 | 18 | 13 | 27.78 |
| | ePTFE (no scrim) | | | | |
| 3) | 0.0035″-thick | 0.21 | 18 | 15 | 16.67 |
| | ePTFE with 2 | | | | |
| | scrim layers | | | | |
| 4) | 0.0035″-thick | 0.21 | 18 | 16 | 11.11 |
| | ePTFE with 4 | | | | |
| | scrim layers | | | | |
| 5) | 0.0035″-thick | 0.21 | 17 | 15.2 | 10.59 |
| | ePTFE with 6 | | | | |
| | scrim layers | | | | |
| 6) | 0.0035″-thick | 1.98 | 18 | 15 | 16.67 |
| | PTFE with 2 | | | | |
| | scrim layers | | | | |

Various combinations of upstream scrim layers, PTFE membrane, superabsorbent media, and downstream wicking layers were tested to determine their effect on the operating life of a gas-liquid separator. The list of materials used in these tests is in Table 4.

TABLE 4
Materials Used to Test Gas-Liquid Separator Designs

| Component | Material |
|---|---|
| Upstream Scrim Layer | Typar ® 3121 L, polypropylene spunbond |
| Microporous Membrane | ePTFE microporous membrane |
| | Tetratec ® TX1111 |
| Downstream Wicking Layer | Wicking material #9 from Table 2 |
| Downstream Superabsorbent | Absorbent Material #1 from Table 1 |
| Layer | |

Table 5 shows that the GLS composite material works much better than a membrane alone in separating gas from the liquid stream and allowing the fuel cell to continue operation. In the test, 50 cc/min of air was bubbled through a liquid flowing at 75-mL/min through a 1-cm×10-cm channel that was 0.5-cm deep. Three sides of the channel were solid aluminum while the top was bounded by the gas-liquid separator material to test. The flow of gas through the separator material was measured and recorded over time. The test was stopped when the flow of gas through the GLS material stopped and bubbles were seen remaining with the liquid flow. Operating life was defined as the length of time the test ran until the gas flow rate through the GLS material dropped to 50% of the starting flow rate. The results show that a gas-liquid separator using wicking and absorbent materials in combination with the membrane allowed the system to operate much longer than a gas-liquid separator that used a membrane alone. The tests also show that designs using scrim layers upstream of the membrane without a downstream superabsorbent layer performed poorly.

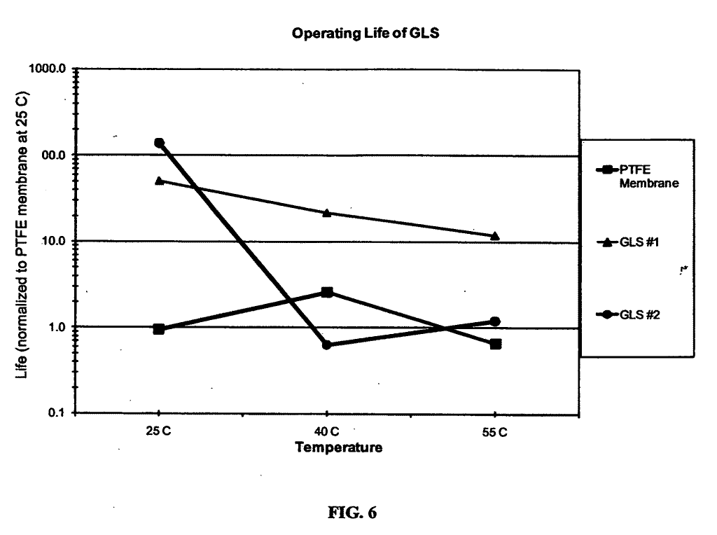

FIG. 6 is a graphical comparison of the relative performance of the composite sample designs vs. designs using a PTFE membrane without any downstream wicking or absorbent layers. In FIG. 6, results for GLS #1 are an average of the results shown in Table 5 for GLS designs that used a membrane, a wicking material, and an absorbent. Results for GLS #2 are an average of the results in Table 5 for GLS designs that used a membrane and absorbent material only. As can be seen in FIG. 6, samples without a wicking layer between the membrane and the absorbent did not perform as well at higher temperatures because the additional vapor that condensed was absorbed by the absorbent at the surface of the membrane, causing the absorbent material to swell shut and restrict air flow. The results show that a wicking layer between the membrane and absorbent allows for the best performance over a range of temperatures. A wide variety of materials can be selected for each layer, depending on the flow properties and operating conditions of the fuel cell.

TABLE 5
Operating Life Improvement from GLS Designs

| | # of | | | | |
|---|---|---|---|---|---|
| | Up- | # of | # of | | |
| | stream | Downstream | Downstream | Temper- | Operating |
| GLS | Scrim | Superabsorbent | Wicking | ature | Life |
| Design | Layers | Layers | Layers | (Celsius) | (hours) |
| | 0 | 0 | 0 | 25 | 0.87 |
| | 0 | 0 | 0 | 25 | 1.05 |
| GLS#1 | 0 | 1 | 1 | 25 | 47.00 |
| GLS#1 | 0 | 1 | 1 | 25 | 54.17 |
| | 2 | 0 | 1 | 25 | 0.55 |
| | 2 | 0 | 1 | 25 | 0.27 |
| GLS #2 | 2 | 1 | 0 | 25 | 130.00 |
| GLS #2 | 2 | 1 | 0 | 25 | 149.00 |
| | 0 | 0 | 1 | 40 | 5.00 |
| | 0 | 0 | 0 | 40 | 4.00 |
| GLS#2 | 0 | 1 | 0 | 40 | 0.28 |
| GLS #1 | 0 | 1 | 1 | 40 | 20.00 |
| | 2 | 0 | 1 | 40 | 0.23 |
| | 2 | 0 | 0 | 40 | 1.25 |
| GLS #1 | 2 | 1 | 1 | 40 | 23.42 |
| GLS #2 | 2 | 1 | 0 | 40 | 1.00 |
| | 0 | 0 | 1 | 55 | 5.00 |
| | 0 | 0 | 1 | 55 | 6.67 |
| GLS #2 | 0 | 1 | 0 | 55 | 1.42 |
| GLS #2 | 0 | 1 | 0 | 55 | 1.00 |
| | 2 | 0 | 0 | 55 | 1.17 |
| | 2 | 0 | 0 | 55 | 0.17 |
| GLS #1 | 2 | 1 | 1 | 55 | 19.00 |

FIG. 7 shows one embodiment of how the components of the gas-liquid separator can be incorporated into flow field plates. FIG. 7 shows a cross-section of a flow field plate 101. The flow fields deliver liquid fuel 112 through the channels 104 to the anode side of the fuel cell where it reacts with the MEA 105. Channels of the flow field are separated by the solid portion 106 of the material used to construct the flow field plate. Carbon dioxide 107 is generated from the anode reaction and bubbles up though the liquid fuel. Gas 110 that escapes the liquid flows through the microporous membrane 103 and the wicking layer, and then out the vent 108. Solution vapor 109 is also produced as the fuel cell heats up. The vapor flows through the membrane and wicking layers; some or all of the vapor condenses before it flows out through the vent openings. The wicking layers absorb the condensed solution vapor and transfer it to the absorbent material 111 which holds the condensed vapor, keeping the main path for gas venting from plugging prematurely. The membrane and wicking layers provide a partition in the flow field plate where one region contains the liquid fuel, and the other contains air space and absorbent material. The membrane and wicking layers can be attached to the solid portions 106 of the flow field plates by mechanical, thermal, or adhesive means. In addition to PTFE, other suitable membrane materials include polypropylene, polyethylene, and polyvinylidene fluoride (PVDF). The membrane must have low surface energy and small pore size to keep the liquid fuel from penetrating the membrane at low pressures, typically 5 psi or less, while maintaining sufficient porosity to effectively vent the vapor.

### Liquid and Air Management at the Cathode

FIG. 8 shows one embodiment for using wicking and absorbent layers to manage water produced at the cathode. Current fuel cells produce water at the cathode site when oxygen from the air steam 50 combines with hydrogen ions 30 diffusing across the membrane stack 20 and electrons 40 generated by the anode-side reaction. If the water is not removed from the cathode surface, it will block the flow of air to the catalyst surface and the power produced by the fuel cell will decrease; this is a condition known as “cathode flooding.” Absorbent materials can be used to remove the water from the cathode, but they must remain open enough to allow air flow through them and also have sufficient capacity to absorb the water produced. The invention uses a composite material comprising an acquisition/wicking layer 60 that faces the cathode and a storage/absorbent layer 70 that is made of a heavier weight material. The acquisition layer initially absorbs the water and then transfers it to the absorbent layer so that it can continually transfer water away from the cathode surface. The absorbent layer is able to store water in discrete locations so that air flow through the layer is not impeded.

The improved design allows for water produced at the cathode site of fuel cells to be transferred away from the cathode while allowing air to continue to flow to the cathode and react. The water can be either stored or transferred to another location for recycling while keeping the air pathway open, allowing for longer operation of the fuel cell. The use of a water-absorbent layer allows for extra capacity for water surges in the event the amount of water production exceeds the amount of water the fuel cell can effectively recycle. By integrating the wicking and absorbent functions into the flow field plate, the fuel cell can manage water at the precise locations where it is produced, minimizing any localized areas of flooding and low reaction conversion. Using the improved design, a fuel cell can release water vapor to the atmosphere over time so that it can continue to operate over long periods of time.

An important feature of the design is that it uses a swellable absorbent to absorb the water produced at the cathode. These absorbents swell as they absorb water. Constraining the swelling of the polymer limits the amount of water that any individual particle can absorb. In an absorbent product, constraining the swelling of any localized areas in the product will force the water to be absorbed by other areas, resulting in a more effective utilization of the absorbent layer and better distribution of water within the absorbent. The pressure exerted by the swelling will also insure that the acquisition/wicking layer maintains good contact with the cathode surface.

The wicking layer is necessary to keep the surface of the cathode site free of water and to transfer water to the areas where the absorbent material is located. Without a wicking layer, the absorbent material would swell at the cathode surface as it first begins to absorb water and its pores would begin to close, blocking further air flow.

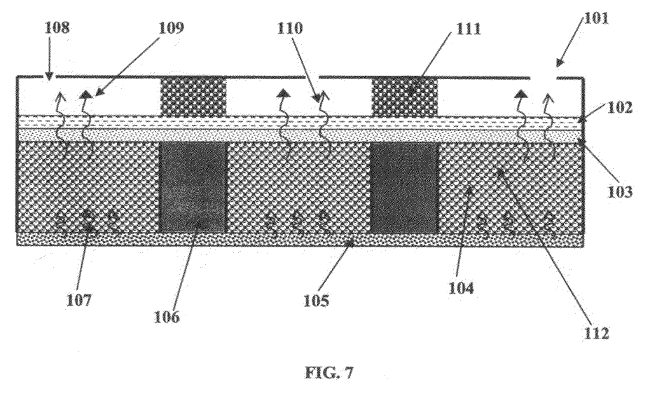

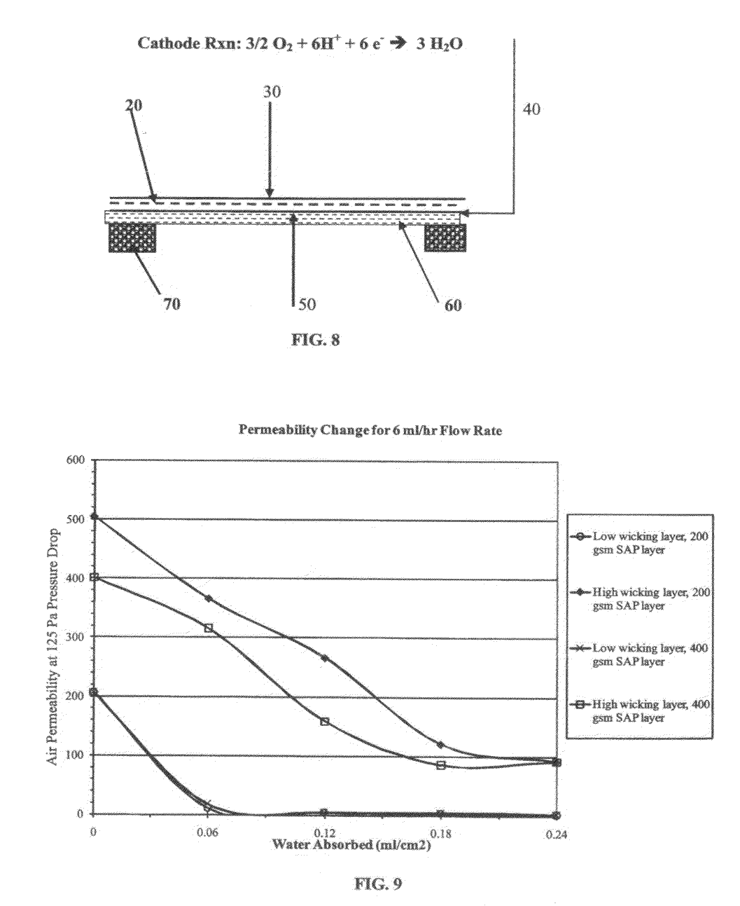

FIG. 9 shows how a wicking layer can be combined with an absorbent layer to maintain air permeability in a material even after the materials have absorbed water. In the tests, combinations of wicking and absorbent layers were wetted with water at a flow rate of 6 ml/hr. The tests used 5-cm×5-cm samples. Air permeabilities (at a pressure drop of 125 Pa) were measured after the samples had absorbed water. In the data shown in FIG. 9, the materials used in the tests are given in Table 6.

TABLE 6
Materials Used

| Sample | Legend Designation | Materials Used |
|---|---|---|
| 1 | Low wicking layer, | Material #5 from Table 2 |
| | 200-gsm SAP layer | Material #4 from Table 1 |
| 2 | High wicking layer, | Material #7 from Table 2 |
| | 200-gsm SAP layer | Material #4 from Table 1 |
| 3 | Low wicking layer, | Material #5 from Table 2 |
| | 400-gsm SAP layer | Material #3 from Table 1 |
| 4 | High wicking layer, | Material #10 from Table 2 |
| | 400-gsm SAP layer | Material #3 from Table 1 |

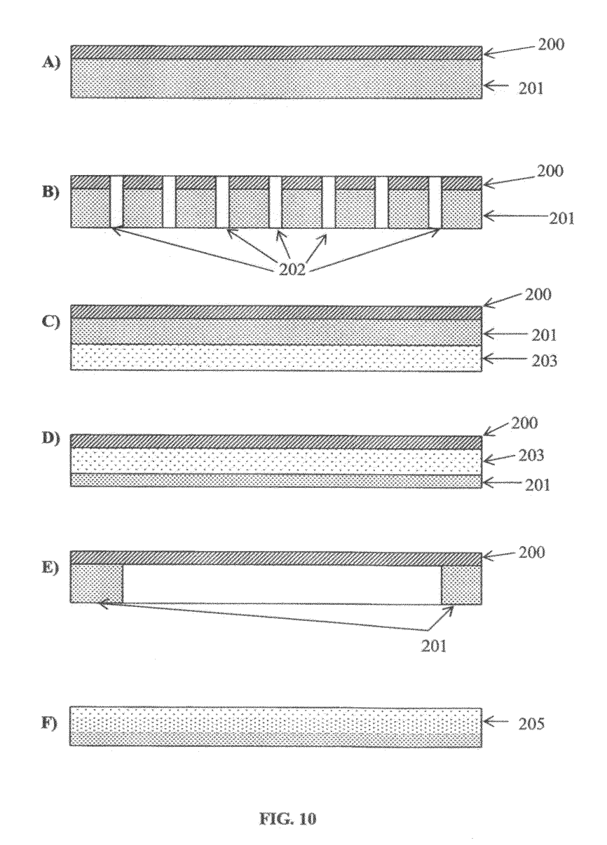

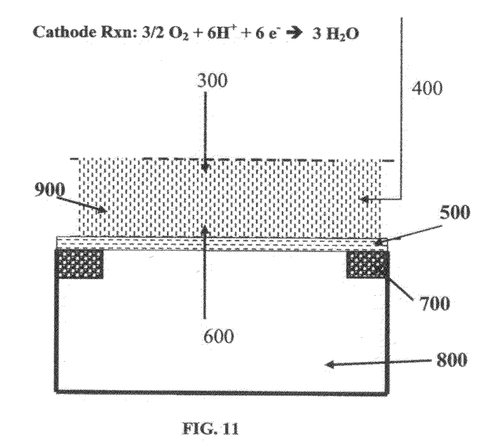

As shown in the figure, materials that used a layer with high wicking properties allowed the final structure to maintain higher air flows when wet than materials that used a layer with low wicking properties. The high wicking property allows the media to transfer water away from the initial area where it is absorbed and distribute it more evenly throughout the structure so that it does not restrict air flow as much. However, either low wicking materials or high wicking materials could be used if the absorbent layer does not lie in the main air flow path and only contacts portions of the wicking layer as shown in FIG. 10E.

FIG. 10 shows additional embodiments for the media layers that could be used to optimize the gas and liquid flows in the fuel cell. In FIG. 10A, a separate wicking/acquisition layer 200 is upstream of the absorbent layer 201 can be a composite material. FIG. 10B shows a composite of wicking and absorbent layers, but with additional holes 202 cut into the material to increase and maintain air permeability. FIGS. 10C and 10D show embodiments of a 3-layer composite where the placement of the more open absorbent layer 203 can vary relative to the less open absorbent layer 201 and wicking layer 200. FIG. 10E shows an embodiment where the absorbent layer 201 only makes fluid contact with portions of the wicking layer 200. FIG. 10F shows an embodiment where the fluid acquisition, wicking, and absorbent functions are all performed by a single gradient density layer 205.

Other specific variations include the following:
Size and shape can vary depending on the application and customer specifications.
Absorbent materials could be located outside the stack but still in fluid contact with wicking materials.
Wicking layers can be conductive.
A gradient structure could be used instead of individual layers in the cathode and anode side materials.
Additional layers could be added to improve wicking or absorption.
Additional holes could be die-cut into the wicking or absorbent materials to maintain high air permeability.
Other peripheral components could be added to improve integration with the device that the fuel cell will power.

FIG. 11 shows one embodiment of how the wicking and absorbent layers of the invention can be incorporated into a flow field plate for systems that provide forced air or other reactants to the cathode site. In this embodiment, channels 800 in the flow field plate deliver oxygen or air 600 to the cathode side of the fuel cell. The oxygen from the air stream combines with hydrogen ions 300 diffusing across the membrane stack 900 and electrons 400 generated by the anode-side reaction to produce water. If the water is not removed from the cathode surface, it will block the flow of air to the catalyst surface and the power produced by the fuel cell will decrease; this is a condition known as “cathode flooding.” The water can be present as either water vapor or condensed water. Absorbent materials remove the water from the cathode, and remain open enough to allow air flow through them and also have sufficient capacity to absorb the water produced. A composite material comprising an acquisition/wicking layer 600 that faces the cathode and a storage/absorbent layer 700 that is made of a heavier weight material is used to remove any condensed water from the cathode.

The figures, examples, data and other technical disclosure provide a basis for understanding the nature of the invention. Many embodiments can be made without departing from the spirit and nature of the invention. The appended claims are intended to cover such embodiments.

I claim:

1) A fuel cell comprising
an anode and cathode,
fuel delivery means comprising a superabsorbent nonwoven absorbent media in fluid contact with a wicking material,
gas-liquid separation means,
and water management means.

2) The fuel cell of claim 1 wherein the superabsorbent nonwoven media comprises a superabsorbent fiber.

3) The fuel cell of claim 2 wherein the superabsorbent nonwoven has a water absorbent capacity greater than 10 g/g.

4) The fuel cell of claim 1 wherein the wicking material comprises a hydrophilic nonwoven material.

5) The fuel cell of claim 4 wherein the wicking material contains less than 1% glass fibers.

6) The fuel cell of claim 1 wherein both the absorbent media and the wicking material have a dry Frazier perm of greater than 20 feet/min.

7) The fuel cell of claim 1 wherein the water-management means comprises a superabsorbent nonwoven material in fluid contact with a wicking material.

8) The fuel cell of claim 1 wherein the gas-liquid separation means comprises a microporous membrane, a wicking material, and a superabsorbent nonwoven media.

9) A fuel cell comprising
an anode and cathode,
fuel delivery means,
water management means, and
gas-liquid separation means comprising
a microporous membrane,
a scrim layer in contact with the membrane, and
a superabsorbent nonwoven material in fluid contact with the scrim layer wherein the surface energy of the scrim layer is higher than the surface energy of the microporous membrane

10) The fuel cell of claim 9 wherein the scrim layer is a wicking layer.

11) The fuel cell of claim 9 further comprising one or more scrim layers on the upstream side of the microporous membrane.

12) The fuel cell of claim 12 further comprising a hydrophobic treatment on the microporous membrane and upstream scrim layers.

13) The fuel cell of claim 9 wherein the microporous membrane has a Frazier air perm greater than 0.1 ft/min.

14) The fuel cell of claim 9 wherein the fuel delivery means comprises a wicking material in fluid contact with a superabsorbent nonwoven material.

15) The fuel cell of claim 9 wherein the water management means comprises a superabsorbent nonwoven material in fluid contact with a wicking material.

16) A fuel cell comprising
an anode and cathode,
fuel delivery means,
gas-liquid separation means, and
water management means comprising a wicking material in fluid contact with a superabsorbent nonwoven material.

17) The fuel cell of claim 16 wherein both the wicking material and the superabsorbent nonwoven materials together have a dry Frazier permeability greater than 100 ft/min.

18) The fuel cell of claim 16 wherein both the wicking material and the superabsorbent nonwoven materials together have a Frazier permeability greater than 10 ft/min after absorbing 0.24 mL of water per square centimeter.

19) The fuel cell of claim 16 wherein the fuel delivery means comprises a wicking material in fluid contact with a superabsorbent nonwoven material.

20) The fuel cell of claim 16 wherein the gas-liquid separation means comprises
a microporous membrane,
a wicking material in contact with the membrane, and
a superabsorbent nonwoven media in fluid contact with the wicking material.
